(19) United States
(12) Patent Application Publication
(10) Pub. No.: US 2016/0346992 A1
(43) Pub. Date: Dec. 1, 2016

(54) SYSTEM, APPARATUS AND METHOD FOR POST-MOLDING INSERTION OF ELECTRICAL CONTACTS

(71) Applicant: Frederick Rowen Agnir, St. Petersburg, FL (US)

(72) Inventor: Frederick Rowen Agnir, St. Petersburg, FL (US)

(73) Assignee: JABIL CIRCUIT, INC., St. Petersburg, FL (US)

(21) Appl. No.: 14/724,671

(22) Filed: May 28, 2015

(51) Int. Cl. B29C 65/08; H01M 2/02; H01M 2/04; B29C 65/02; B29C 65/72

(52) U.S. Cl. CPC B29C 65/08; B29C 65/02; B29C 65/72; H01M 2/0434; H01M 2/0202; H01M 2/043; B29L 2022/00

(57) ABSTRACT

An apparatus, system and method for inserting a contact having an insert portion, a textured portion and a head portion, into a surface of a molded shell made of plastic or other similar material. An opening is provided in a portion of the molded shell that is smaller in size than the contact and the contact is aligned into the opening. Energy, such as heat energy, ultrasonic energy, and/or infrared energy may be applied to the contact at one or more predetermined energy levels sufficient to cause the substrate to at least begin melting, and a force may be applied to the heated contact to push the heated contact into the substrate such that the plastic material forms a seal around the textured portion.

### FIELD OF THE DISCLOSURE

The present disclosure relates to insertion of devices and/or materials into molded surfaces. More specifically, the present disclosure relates to post-molding insertion of sealed electrical contacts into thermoplastic.

### BACKGROUND

In electrical, electro-mechanical and/or industrial applications, there is often a need to insert devices and/or materials into a casing to provide an electrical, mechanical, or other type of connection to external parts or devices. In some instances, a plastic or thermoplastic case may be molded, and must be arranged to accommodate a plurality of different connector configurations. Of course, individualized or customized molds may be created to accommodate each different configuration, but such an arrangement is exceedingly costly and inefficient.

Drawbacks of such an approach are compounded in instances where a casing contains liquids, or similar materials, and particularly when these materials have corrosive properties. For example, casings are typically required for battery applications, such as electrolytic cells. An electrolytic cell is an electrochemical cell that undergoes a redox reaction when electrical energy is applied, and may be used to decompose chemical compounds using electrolysis. When electrical energy is added to the system, the chemical energy is increased. Similarly to a galvanic cell, electrolytic cells may include a plurality of half cells. Examples of electrolysis may include the decomposition of water into hydrogen and oxygen, and bauxite into aluminum and other chemicals. By way of non-limiting example, electroplating (e.g. of copper, silver, nickel or chromium) may be performed using an electrolytic cell.

A simple electrolytic cell may comprise a plurality of component parts, including an electrolyte and electrodes (e.g., a cathode and an anode). The electrolyte may be a solution of water or other solvents in which ions are dissolved. Molten salts such as sodium chloride and other suitable materials may be used as electrolytes. When driven by an external voltage applied to the electrodes, the ions in the electrolyte are attracted to an electrode with the opposite charge, causing charge-transferring (also known as faradaic or redox) reactions to take place. Using an external electrical voltage of correct polarity and sufficient magnitude, an electrolytic cell can decompose a normally stable or inert chemical compound in the solution to provide electrical energy.

As such configurations require mechanical couplings for electrical (and other) contact, techniques to provide appropriate insertions into molded arrangements may be desirable. Additionally, it may be desirous that such insertions may be configured to maintain the integrity of the molding, particularly to prevent the leakage of fluids, gases or other materials that may be contained within a molding assembly without the usage of additional sealing adhesives and/or gaskets.

### SUMMARY

Accordingly, at least of the illustrative embodiments disclose methods for inserting a contact, having an insert portion, a textured portion and a head portion, into a substrate having a plastic material, of the method including positioning the contact with an opening in the substrate configured to partially receive the contact; applying energy to at least one of the contact and the substrate at one or more predetermined energy levels sufficient to cause the substrate to at least begin softening; and applying a force to at least one of the energized contact and the energized substrate to push the heated contact into the substrate such that the plastic material forms a seal around the textured portion when it cools.

In certain embodiments, there may be provided a plastic shell assembly including a contact having an insert portion, a textured portion and a head portion, and a substrate surface portion of the plastic shell assembly, wherein the contact is configured to be inserted into the substrate surface portion by positioning the contact into an opening of the substrate configured to partially receive the contact, applying energy to at least one of the contact and the substrate at one or more predetermined energy levels sufficient to cause the substrate surface portion to at least begin softening, and applying a force to at least one of the energized contact and the energized substrate to push the heated contact into the substrate surface portion such that plastic material of the substrate surface portion forms a seal around the textured portion when it cools.

In still further illustrative embodiments, a method is disclosed for inserting a metallic contact, comprising an insert portion, a textured portion and a head portion, into a surface of a molded shell comprising a plastic material, comprising the steps of positioning the contact into an opening of the substrate configured to partially receive the contact; applying energy to at least one of the contact and the substrate at one or more predetermined energy levels sufficient to cause the portion of the molded shell to at least begin softening; and applying a force to at least one of the energized contact and energized substrate to push the heated contact into the molded shell such that the plastic material forms a seal around the textured portion when it cools.

### BRIEF DESCRIPTION OF THE FIGURES

The present disclosure will become more fully understood from the detailed description given herein below and the accompanying drawings which are given by way of illustration only, and which thus do not limit the present disclosure, and wherein:

FIG. 1 shows a heat insert comprising an insert portion, a knurled portion and a head portion according to an illustrative embodiment;

FIGS. 1A-1B show another heat insert comprising an insert portion, a knurled portion and a head portion according to another illustrative embodiment;

FIGS. 2A-2C illustrate an process for preparing a surface for inserting a heat insert prior to thermal pressing according to an embodiment;

FIG. 3 illustrates a bottom shell portion of an electrolytic cell configured for connector attachment;

FIG. 4A shows a bottom shell portion of an electrolytic cell configured for connector insertion utilizing a heat insert according to an illustrative embodiment;

FIG. 4B shows a top shell portion of an electrolytic cell configured to be attached to the bottom shell portion disclosed in FIG. 4A according to an illustrative embodiment;

FIG. 4C shows the top shell portion disclosed in FIG. 4A in the process of coupling to the bottom shell portion disclosed in FIG. 4B to form a shell assembly according to an illustrative embodiment;

FIGS. 5A-5C show various conductor plates for placement into a shell assembly according to illustrative embodiments;

FIG. 6 shows placement of a conductor plate on a bottom shell portion utilizing a gasket according to an illustrative embodiment;

FIGS. 7A-7B show an external contact arrangement for a shell assembly according to an illustrative embodiment;

FIGS. 8A-8B show a conductor plate stack arrangement for a shell assembly according to an illustrative embodiment;

FIG. 9 shows a top-loading holder for a shell assembly according to an illustrative embodiment; and

FIG. 10 shows a holster for a shell assembly according to an illustrative embodiment.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided here throughout. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

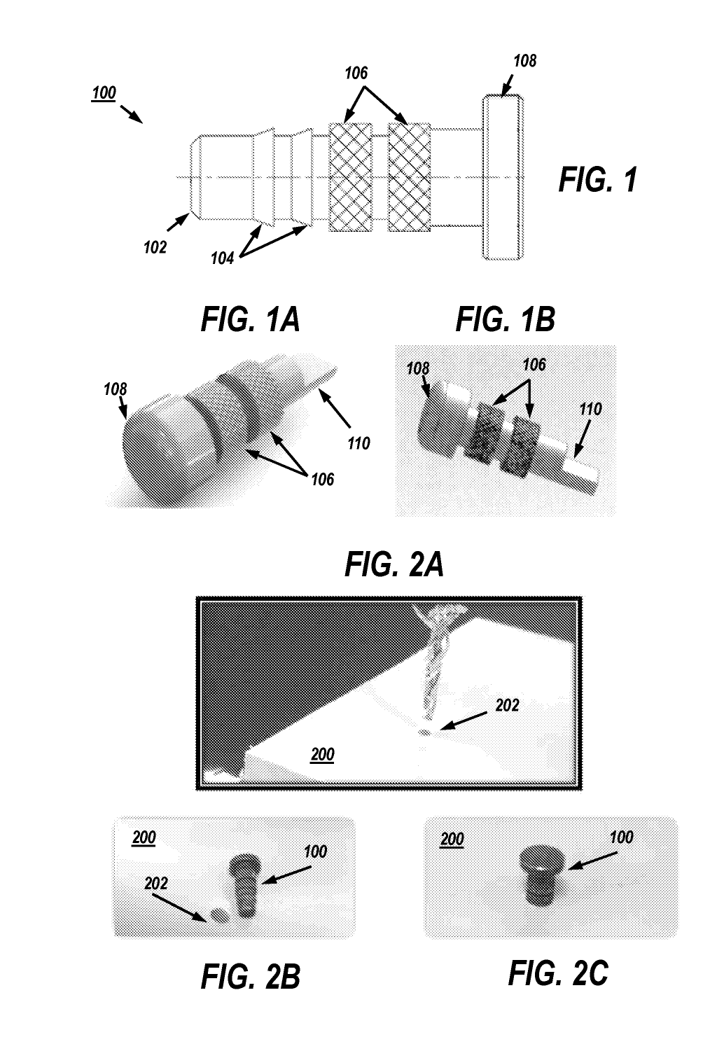

Turning now to FIG. 1, an illustrative embodiment is shown of a heat insert 100 that may be manufactured from a corrosion-resistant and heat-resistant metal or alloy, including, but not limited to, brass, brass alloys (e.g., 360 Brass), black zinc, etc. Heat insert 100 may be configured to have an insert portion 102 that may comprise a beveled edge 103 to ease insertion, a fastening portion 104 to assist holding heat insert 100 in place after insertion, a textured or “knurled” portion 106 for forming a seal gland and securing heat insert 100 within a surface, and a head portion 105 for securing heat insert 100 to a top surface after insertion.

FIGS. 1A and 1B show another embodiment of heat insert 100, utilizing the knurled portion 106 for securing heat insert 100 within a surface after insertion and head portion 108 for securing heat insert 100 to a top surface after insertion. In the embodiments of FIGS. 1A-1B, an electrical contact end 110 is provided for allowing a contact surface for electrical connection. It should be understood by those skilled in the art that a variety of materials and/or configurations are contemplated by the present disclosure. For example, while two knurled portions are shown in the figures, a greater or lesser number may be used, and other textures or patterns may be used for portion 106 to secure the heat insert. Furthermore, other head portion configurations for 108 may be used, such as pan heads, truss heads, wafer heads, flat heads, round heads, fillister heads, and the like.

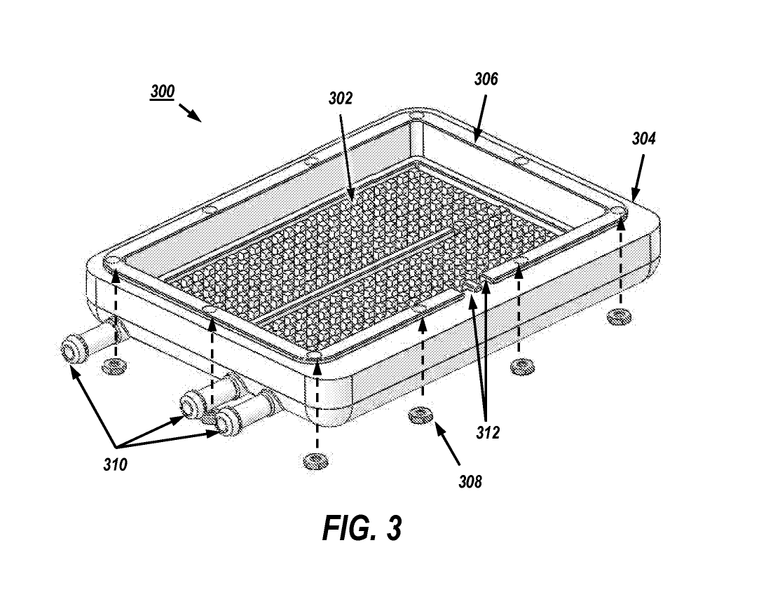

Referring now to FIGS. 2A-2C, an exemplary process is disclosed for securing heat insert 100 into a surface or substrate, which, in this example, comprises a plastic or thermoplastic, such as chlorinated polyvinyl chloride (CPVC) or high-density polyethylene (HDPE), or any other suitable material that softens and is pliable or moldable above a specific temperature and solidifies at least partially upon cooling. As shown in FIG. 2A, a hole or opening 202 may be created via drilling or other suitable means in substrate 200. Heat insert 100 may be aligned to, and/or positioned over, hole 202 in FIG. 2B and placed or pre-inserted into hole 202 as shown in FIG. 2C.

In certain illustrative embodiments, using a thermal press (e.g., Sonitek TS-100) or other suitable manually-operated or automated machinery capable of applying heat-inducing energy, a thermal press probe from the thermal press comes into contact with heat insert 100 and heats the insert 100 to a predetermined temperature (e.g., 360°-400° F.) until the heat emanating from the insert 100 begins to soften or melt the surrounding substrate 200 material in hole 202. When the substrate 200 begins softening/melting, pressure is applied to the heat insert 100 to push the insert 100 further into the surface of substrate 200 via hole 202 and is stopped once the head portion 108 comes into contact with the surface of the substrate 200. Depending on the energy level that is applied and/or the thickness and/or melting properties of the substrate, energy to the insert 100 may be stopped just before, during or after insertion. In a non-limiting example, a higher heat temperature may be used to heat the insert 100. Prior to insertion into hole 202, the heat source may be turned off and the residual heat in insert 100 will continue to soften/melt the surrounding substrate material of hole 202 during insertion. In another non-limiting example, heat may be applied to insert 100 before and/or during insertion to ensure that adequate heat is being provided to soften/melt substrate material surrounding hole 202. Such a configuration may be advantageous when an insert 100 is being inserted into a thicker substrate, and/or a substrate that is made from a material with a lower melt-flow index (MFI). In another non-limiting example, heat may be continuously applied to insert 100 until it is fully inserted. Such a configuration may be advantageous when an insert (e.g., 100) is being inserted into a thinner substrate and/or a substrate having a higher MFI. In this example, a lower heat (e.g., at or slightly above (<2%) the melting point) would preferably be applied throughout the insertion process.

The insertion techniques described above may be advantageous in applications where the electrical contact insert is needed for a shell assembly or vessel, particularly ones containing fluid that may be corrosive, or ones containing gaseous material. By applying energy to heat the insertion area in a vessel wall, a contact (e.g., insert 100) may be pressed into the at least partially softened/melted insertion area to secure the contact. In certain embodiments, the softened/melting plastic may flow around the contact and into seal glands to create a sealed electrical contact. In certain embodiments, no additional adhesive sealants, gaskets or O-rings are required, which in turn save labor and material costs. In certain embodiments, similar results may be achieved using ultrasonic insertion, hot air/cold stake insertion, infrared heat insertion, or any suitable technology that provides energy sufficient to soften/melt a substrate. In certain tests, heat inserts were capable of holding 25 inches of mercury vacuum until disconnected (˜12.28 psig), although higher or lower pressure configurations are contemplated in the present disclosure. The above-referenced heat insertion was also capable of providing a substantially leak proof connection (e.g., pressure decay up to 10 psig).

In some illustrative embodiments, heat or energy may be applied to an area surrounding hole 202 of substrate 200 in addition to, or instead of, applying heat or energy to insert 100. In one non-limiting example, heat may be applied to one or both sides of a substrate in the area of hole 202 to soften/melt the substrate material prior to, during and/or throughout the insertion process. In another non-limiting example, when using ultrasonic insertion, vibration energy may be applied to the substrate (e.g., 200) to generate the necessary friction heat to drive insert 100 into hole 202.

It should be understood by those skilled in the art that, while certain embodiments described herein may generally be directed towards electrolytic cells, the technologies are not intended to be so limited. Other suitable applications include temperature and/or pressure sensors, manifold sensors and the like. Generally, the sealed heat insertion of electrical contacts may be suitable for any application requiring electrical contact within a fluid or gas medium.

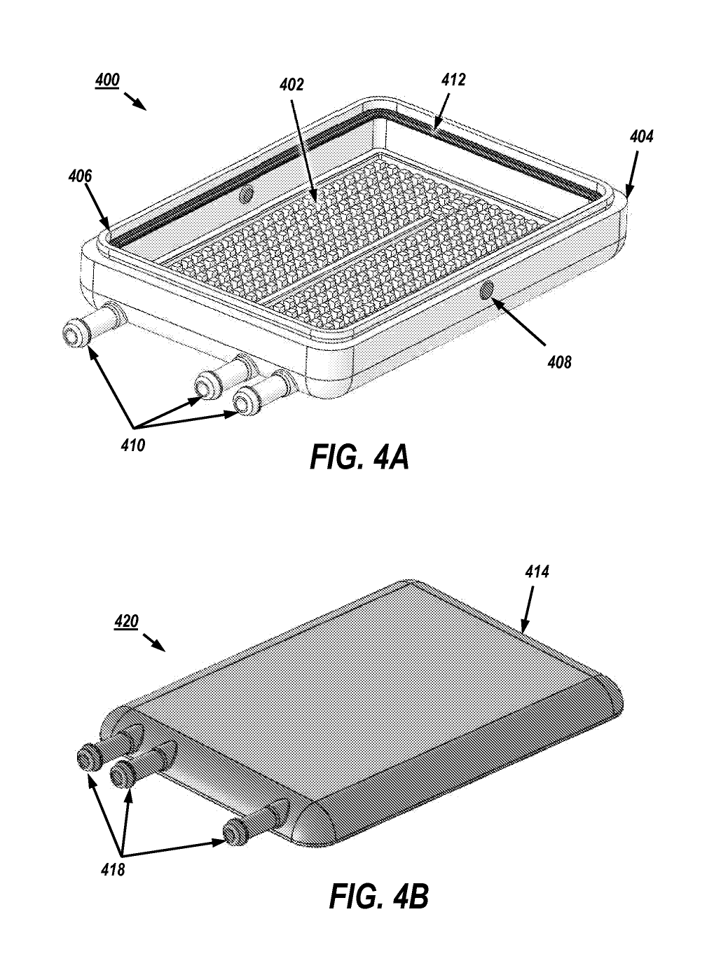

Turning to FIG. 3, a bottom shell portion 300 of an electrolytic cell, or other device configured to hold a fluid, is shown under a conventional configuration. Here, the bottom shell 300 includes a one or more fluid ports 310 and a bottom groove portion 302 configured to provide a fluid path for conductor plate connectors, discussed in greater detail below. In order to provide a seal for bottom shell portion 300 to a top portion, a gasket 306 is required to be placed on shell surface 304, which is tightened down using a plurality of nuts or fasteners 308. In order to provide access for electrical connectors, one or more openings 312 may be provided in the gasket 306 to allow for a contact to be placed and sealed using additional sealant, gaskets, and the like.

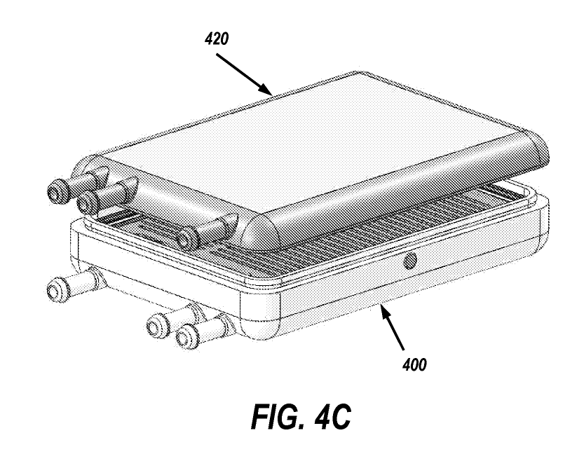

FIG. 4A shows a bottom shell portion 400 of an electrolytic cell, or other device configured to hold a fluid, configured for connector insertion utilizing a heat insert as discussed above according to an illustrative embodiment. Bottom shell portion 400 includes one or more fluid ports 410 and a bottom groove portion 402 configured to provide a fluid path for conductor plate connectors, discussed in greater detail below. Unlike the bottom shell portion 300 of FIG. 3, bottom shell portion 400 includes snap lid 406 running along the perimeter of surface 404 of bottom shell portion 400. Snap lid 406 is configured to couple and seal bottom shell portion 400 to the top shell portion 500. Snap lid 406 may be manufactured using a two-shot mold and may additionally utilize an integrated gasket 412 (e.g., Viton™) molded into shell 400 for added leakage protection and eliminate the need for separate gaskets such as gasket 305 of FIG. 3. In one illustrative embodiment, snap lid 406 may be coupled using hot plate welding, which may eliminate the need for the gasket 412.

In the illustrated embodiment, bottom shell portion 400 may also include integrated contact area 408 configured to receive one or more heat contacts, such as those illustrated above in connection with FIGS. 1-2C. Utilizing such heat insertion techniques, a customized electrical contact may be provided to bottom shell portion 400 without requiring a special mold or additional materials (e.g., sealant, gasket) for lower shell 400. Additionally, the heat insertion of an electrical contact (e.g., 100) may be accomplished without blemishing and/or potentially compromising the integrity of shell 400 while maintaining a leak-proof seal. Of course, the integrated contact area 408 may be located along any side of bottom shell portion 400, depending on the desired location of the contact.

FIG. 4B shows a top shell portion 420 of an electrolytic cell, or other device configured to hold a fluid, having a cover 414 having fluid ports 418 and configured to be attached to the bottom shell portion 400 disclosed in FIG. 4A according to an illustrative embodiment. In one embodiment, the top shell portion 420 does not have conductor plate grooves (e.g., 402) on the interior, and may be configured with a top shell portion snap lip to couple with snap lid 406 of bottom shell portion 400. The top shell portion 420 and bottom shell portion 400 are shown in FIG. 4C just prior to assembly.

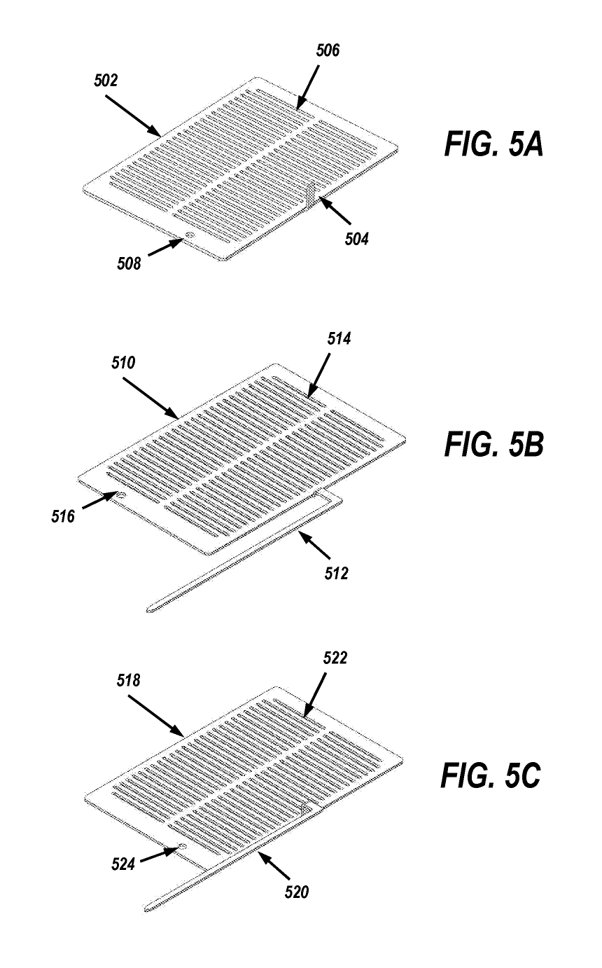

FIGS. 5A-5C show various conductor plates for placement into a shell assembly (e.g., top shell portion 420 coupled to bottom shell portion 400) under illustrative embodiments. In FIG. 5A, a conductor plate 502 is shown comprising conductor plate openings 506 and alignment hole 508, which may be used to ensure conductor plate 502 is installed in a proper orientation. Conductor plate 502 may further include one or more electrical contacts, which is illustrated in FIG. 5A as contact 504. In some embodiments, contact 504 may be an extended tab or a bent tab, as show in FIG. 5A that extends to an exterior of a shell assembly to allow electrical mating (e.g., via plug, connector, etc.) thereto. Conductor plate 502, as well as other conductor plates disclosed herein, may be coated or uncoated plated, depending on the application.

FIG. 5B shows connector plate 510 according to an illustrative embodiment having similar conductor plate openings 514 and alignment hole 516, but has an “L” shaped contact 512 extending laterally and transversally along the plane of connector plate 510. FIG. 5C shows connector plate 518 according to another illustrative embodiment having similar conductor plate openings 522 and alignment hole 524, but has an offset “L” shaped contact 522 elevated and extending laterally and transversally along the plane of connector plate 518. It should be understood by those skilled in the art that various plate and contact (e.g., 504, 512, 520) configurations are contemplated in the present disclosure and are not limited to those expressly disclosed herein.

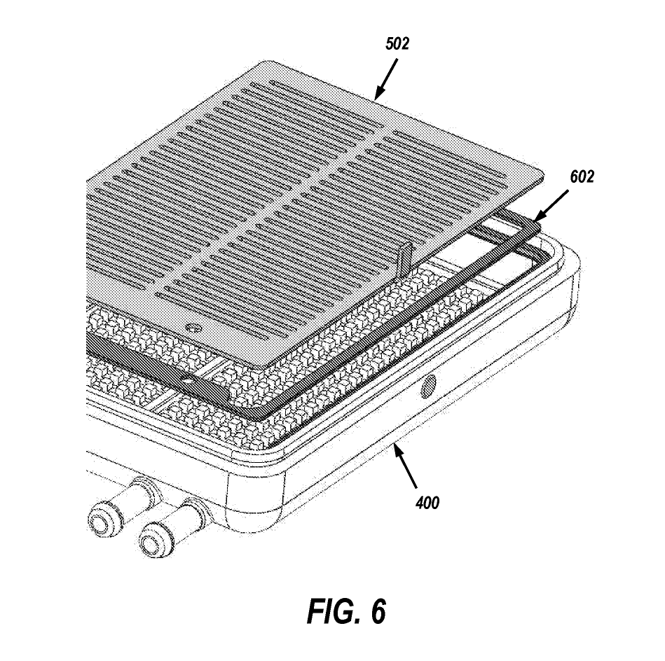

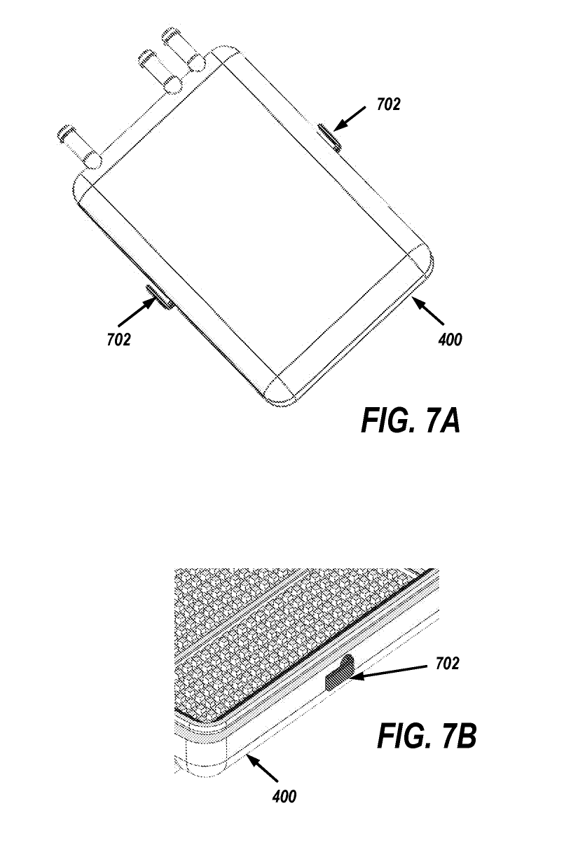

FIG. 6 shows placement of a conductor plate (e.g., 502) on a bottom shell portion 400 utilizing a conductor plate gasket 602 according to an illustrative embodiment. Here, the conductor plate gasket 602 may serve to further protect and/or isolate the conductor plate 502 from corrosion, vibration, spring memory, material change, pressure change, etc. FIGS. 7A-7B show an external contact arrangement for the shell assembly 400 according to an illustrative embodiment. Here, an alternate contactor arrangement is shown, where contacts 702 are configured laterally along the side of assembly 400 as male electrical plugs that allow electrical connection with minimal protrusion from the face of assembly 400

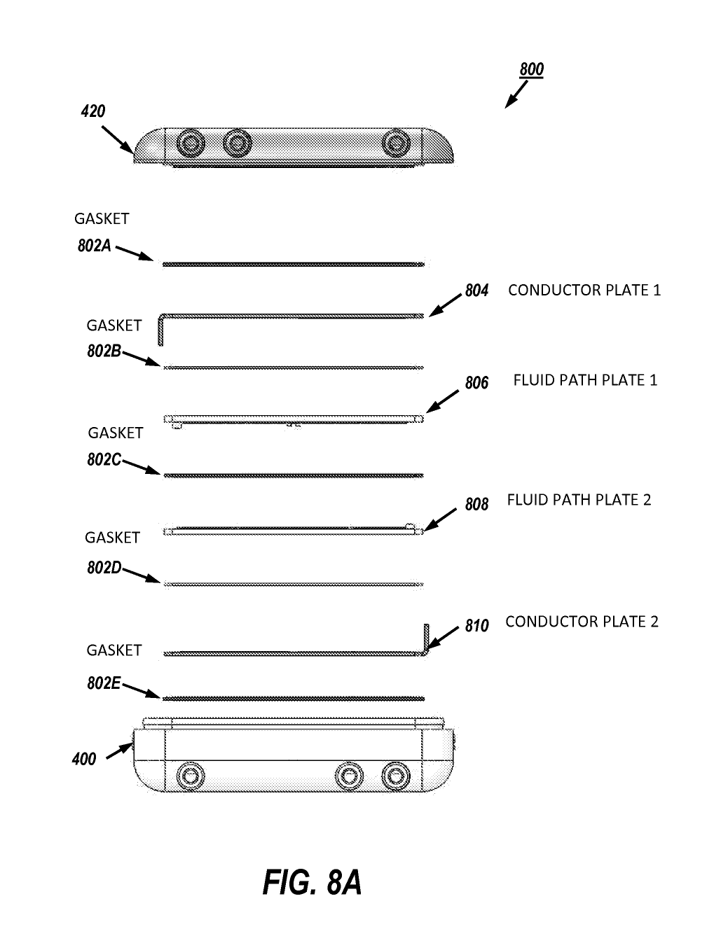

FIGS. 8A-8B show a conductor plate stack arrangement for a shell assembly 800 according to an illustrative embodiment. In this example, a top shell 420 is configured to couple to bottom shell 400 and includes a conductor plate 804 that may be configured as a cathode or anode, where conductor plate 804 is isolated from top shell 420 via gasket 802A and includes gasket 802B sandwiched between conductor plate 804 and fluid path plate 806. The conductor plate 810 may be configured as a cathode or anode, and is isolated from bottom shell 400 via gasket 802E and includes gasket 802D sandwiched between conductor plate 810 and fluid path plate 808. Fluid path plates 808 and 806 may be configured to have a gasket 802C arranged between them.

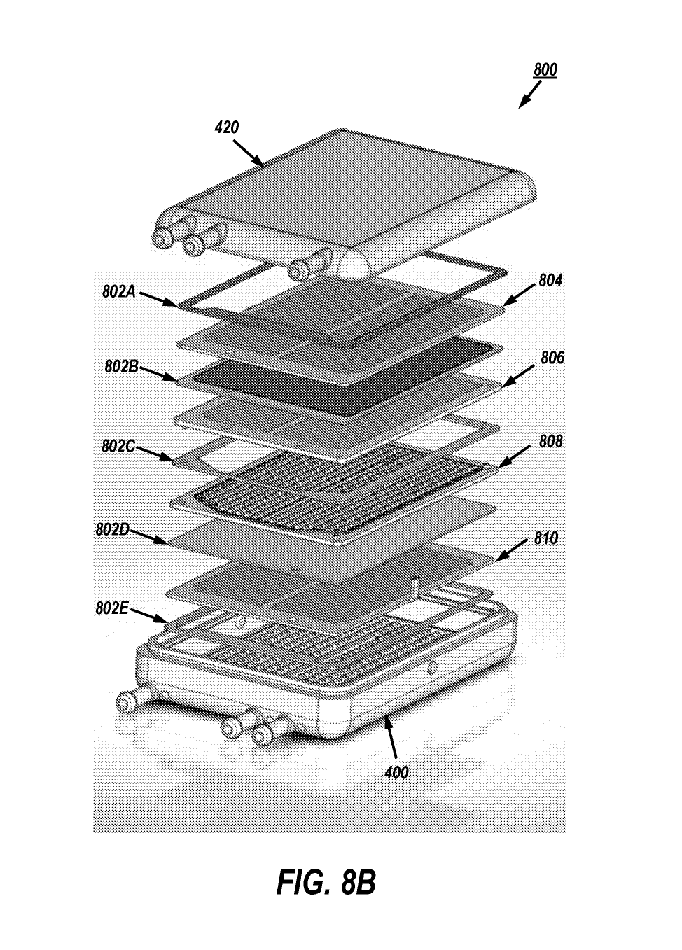

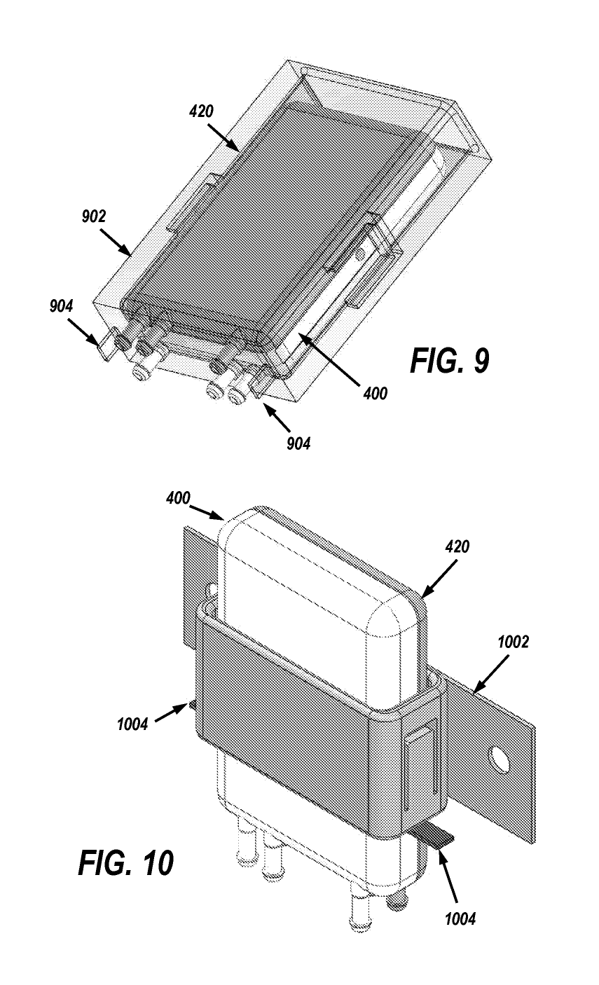

The conductor plate stack arrangements disclosed herein may be configured for insertion to a holding assembly or holster. FIG. 9 shows a top-loading holder 902 for a shell assembly 420 according to an illustrative embodiment. Shell assembly 420 may be slid or otherwise secured into holder 902, where electrical contacts 904 are provided on a front exterior of holder 902. FIG. 10 shows a holster 1002 for a shell assembly (400, 420) according to an illustrative embodiment, where electrical contacts 1004 are provided on a side exterior portion.

In the foregoing detailed description, it can be seen that various features are grouped together in individual embodiments for the purpose of brevity in the disclosure. This method of disclosure is not to be interpreted as reflecting an intention that the subsequently claimed embodiments require more features than are expressly recited in each claim.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather are to be accorded the widest scope consistent with the principles and novel features disclosed herein.

What is claimed is:

1. A method for inserting a contact, having an insert portion, a textured portion and a head portion, into a substrate having a plastic material, the method comprising:
positioning the contact into an opening in the substrate configured to partially receive the contact;
applying energy to at least one of the contact and the opening at one or more predetermined energy levels sufficient to cause the substrate to at least begin softening; and
pushing the heated contact into the substrate such that the plastic material forms a seal around the textured portion of the contact when it cools.

2. The method of claim 1, wherein the energy comprises one of heat, ultrasonic energy and infrared heat.

3. The method of claim 1, wherein the substrate comprises a portion of a molded shell.

4. The method of claim 3, wherein the molded shell comprises a molded shell of an electrolytic cell.

5. The method of claim 3, wherein the molded shell comprises a snap lid.

6. The method of claim 4, further comprising coupling the molded shell to another molded shell via the snap lid.

7. The method of claim 5, further comprising hot plate welding the molded shell to the another molded shell.

8. The method of claim 1, further comprising coupling the contact to one or more conductor plates after the plastic material forms a seal around the textured portion.

9. A plastic shell assembly, comprising:
a contact comprising an insert portion, a textured portion and a head portion; and
a substrate surface portion of the plastic shell assembly, wherein the contact is configured to be inserted into the substrate surface portion by positioning the contact into an opening in the substrate surface configured to partially receive the contact, applying energy to at least one of the contact and the substrate at one or more predetermined energy levels sufficient to cause the substrate surface portion to at least begin softening, and pushing the heated contact into the substrate surface portion such that plastic material of the substrate surface portion forms a seal around the textured portion when it cools.

10. The plastic shell assembly of claim 9, wherein the energy comprises one of heat, ultrasonic energy and infrared heat.

11. The plastic shell assembly of claim 9, wherein the plastic shell assembly comprises a molded shell.

12. The plastic shell assembly of claim 11, wherein the molded shell comprises a molded shell of an electrolytic cell.

13. The plastic shell assembly of claim 11, wherein the molded shell comprises a snap lid.

14. The plastic shell assembly of claim 13, further comprising coupling the molded shell to another molded shell via the snap lid.

15. The plastic shell assembly of claim 14, wherein the molded shell is coupled to the another molded shell via hot plate welding.

16. A method for inserting a metallic contact, having an insert portion, a textured portion and a head portion, into a surface of a molded shell having a plastic material, the method comprising:
positioning the contact into an opening in the molded shell configured to partially receive the contact;
applying energy to at least one of the contact and the substrate at one or more predetermined energy levels sufficient to cause the portion of the molded shell to at least begin softening; and
pushing the heated contact into the molded shell such that the plastic material forms a seal around the textured portion when it cools.

17. The method of claim 16, wherein the energy comprises one of heat, ultrasonic energy and infrared heat.

18. The method of claim 16, wherein the molded shell comprises a molded shell of an electrolytic cell.

19. The method of claim 18, further comprising coupling the molded shell to another molded shell via a snap lid.

20. The method of claim 19, further comprising hot plate welding the molded shell to the another molded shell.
